(19) United States
(12) Patent Application Publication
(10) Pub. No.: US 2007/0180373 A1
(43) Pub. Date: Aug. 2, 2007

(54) Method and system for renderring application text in one or more alternative languages

(76) Inventors: Brian D. Bauman, Austin, TX (US); Amanda J. Burton, Austin, TX (US); Michael P. Carlson, Austin, TX (US); Herman Rodriguez, Austin, TX (US)

Correspondence Address: IBM CORP (YA);C/O YEE & ASSOCIATES PC, P.O. BOX 802333, DALLAS, TX, 75380, US

(21) Appl. No.: 11/343,190

(22) Filed: Jan. 30, 2006

(51) Int. Cl. G06F 17/00

(52) U.S. Cl. 715/535

(57) ABSTRACT

A method, system, and computer program product for selectively displaying alternative language representations of text rendered by an application executing on a computer system.

### BACKGROUND

1. Technical Field of the Present Invention

The present invention generally relates to display devices, and more specifically, to methods, systems, and computer program products that execute applications that support one or more languages.

2. Description of Related Art

The rapid globalization of economies and their dependence upon various aspects of technology has resulted in an exponential growth of the market for software driven applications.

Software companies are increasingly finding themselves in the unique position of either expanding their market, and thus profits, into these growing economies or risk losing the potential market to an existing or new competitor.

Global software applications are typically developed by writing the application in a preferred language (e.g. English or German), debugging and testing, and then translating the final version of the application into the various languages required by the desired markets.

The process of translating an application to a non-native language is time consuming and tedious. The translation itself is not just a matter of simply substituting a native phrase or word for a non-native one, but rather, the translator must take into account the context of the phrase or word.

Although there are various methods for translating the application, a common theme is that the translator is often required to work with the executing application while making notes, screen shots (a static copy of the current view of the display device executing the application), and the like to indicate the required changes or verify that the required changes were made correctly.

For example, a translator will execute the native application, take screen shots, and indicate the required changes either in notes or on the screen shots themselves. These changes are provided to a programmer or other individual who has authorization to modify the application. The translator reviews each screen of the modified application and compares the changes with screen shots and/or notes as previously described. The need to work with two separate documents during the translation process increases the risk of introducing errors.

It would, therefore, be a distinct advantage if the translator were able to execute the translated application and view both the native language and the translation at the same time.

### SUMMARY OF THE PRESENT INVENTION

In one aspect, the present invention is a method of displaying alternative languages for text rendered by an application executing on a computer system. The method includes the step of displaying the text of one or more components. The method also includes the step of selecting an alternative language for the one or more of the components. The method further includes the step of dynamically altering the text of the one or more components to match the selected alternative language.

### BRIEF DESCRIPTION OF THE DRAWINGS

The present invention will be better understood and its numerous advantages will become more apparent to those skilled in the art by reference to the following drawings, in conjunction with the accompanying specification, in which:

FIG. 1 is a block diagram illustrating a computer system that implements a preferred embodiment of the present invention;

FIG. 2 is a diagram illustrating an example of a graphical representation of a window generated during the execution of the application software of FIG. 1 according to the teachings of a preferred embodiment of the present invention;

FIGS. 3, 4, 5 and 6 are diagrams illustrating the window example of FIG. 2 with the user selecting the accounts to be displayed in an alternative language according to the teachings of a preferred embodiment of the present invention;

FIGS. 7, 8, and 9 are diagrams illustrating the window example of FIG. 2 with the user selecting the save button to be displayed in an alternative language according to the teachings of a preferred embodiment of the present invention;

FIGS. 10 and 11 are diagrams illustrating the window example of FIG. 2 with the user selecting the entire window to be displayed in an alternative language according to the teachings of a preferred embodiment of the present invention;

FIG. 12 is a flow chart illustrating the method used by the application of FIG. 1 to render one or more of its components in an alternative language according to the teachings of the present invention; and

FIG. 13 is a data structure diagram illustrating a preferred data structure for the displayed components of the window of FIG. 2 according to a preferred embodiment of the present invention.

### DETAILED DESCRIPTION OF THE PREFERRED EMBODIMENT OF THE PRESENT INVENTION

The present invention is a method, system, and computer program product for selectively displaying the text of an application in its native language and/or an alternative language. The end user is provided with the option of selecting one or more of the components in a window to be displayed in an alternative language. The display of the alternative language can be rendered by the component itself or a separate window with the alternative representation of the component.

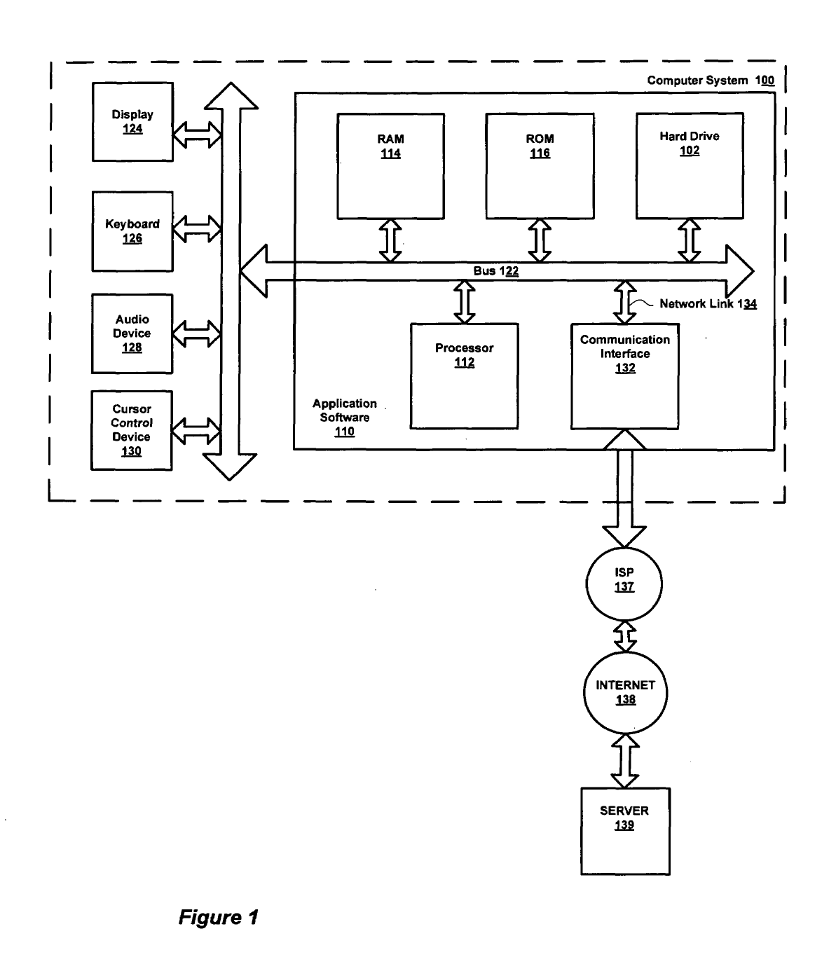

Reference now being made to FIG. 1, a block diagram is shown illustrating a computer system 100 that implements a preferred embodiment of the present invention. Computer System 100 includes various components each of which are explained in greater detail below.

Bus 122 represents any type of device capable of providing communication of information within Computer System 100 (e.g., System bus, PCI bus, cross-bar switch, etc.)

Processor 112 can be a general-purpose processor (e.g., the PowerPC™ manufactured by IBM or the Pentium™ manufactured by Intel) that, during normal operation, processes data under the control of an operating system and application software 110 stored in a dynamic storage device such as Random Access Memory (RAM) 114 and a static storage device such as Read Only Memory (ROM) 116. The operating system preferably provides a graphical user interface (GUI) to the user.

The present invention, including the alternative preferred embodiments, can be provided as a computer program product, included on a machine-readable medium having stored on it machine executable instructions used to program computer system 100 to perform a process according to the teachings of the present invention.

The term “machine-readable medium” as used in the specification includes any medium that participates in providing instructions to processor 112 or other components of computer system 100 for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the preferred embodiment, an example of a non-volatile medium is the Hard Drive 102.

Volatile media includes dynamic memory such as RAM 114. Transmission media includes coaxial cables, copper wire or fiber optics, including the wires that comprise the bus 122. Transmission media can also take the form of acoustic or light waves, such as those generated during radio wave or infrared data communications.

Moreover, the present invention can be downloaded as a computer program product where the program instructions can be transferred from a remote computer such as server 139 to requesting computer system 100 by way of data signals embodied in a carrier wave or other propagation medium via network link 134 (e.g., a modem or network connection) to a communications interface 132 coupled to bus 122.

Communications interface 132 provides a two-way data communications coupling to network link 134 that can be connected, for example, to a Local Area Network (LAN), Wide Area Network (WAN), or as shown, directly to an Internet Service Provider (ISP) 137. In particular, network link 134 may provide wired and/or wireless network communications to one or more networks.

ISP 137 in turn provides data communication services through the Internet 138 or other network. Internet 138 may refer to the worldwide collection of networks and gateways that use a particular protocol, such as Transmission Control Protocol (TCP) and Internet Protocol (IP), to communicate with one another. ISP 137 and Internet 138 both use electrical, electromagnetic, or optical signals that carry digital or analog data streams. The signals through the various networks and the signals on network link 134 and through communication interface 132, which carry the digital or analog data to and from computer system 100, are exemplary forms of carrier waves transporting the information.

In addition, multiple peripheral components can be added to computer system 100. For example, audio device 128 is attached to bus 122 for controlling audio output. A display 124 is also attached to bus 122 for providing visual, tactile or other graphical representation formats. Display 124 can include both non-transparent surfaces, such as monitors, and transparent surfaces, such as headset sunglasses or vehicle windshield displays.

A keyboard 126 and cursor control device 130, such as mouse, trackball, or cursor direction keys, are coupled to bus 122 as interfaces for user inputs to computer system 100.

The execution of application software 110 on computer system 100 according to a preferred embodiment of the present invention is explained in greater detail below.

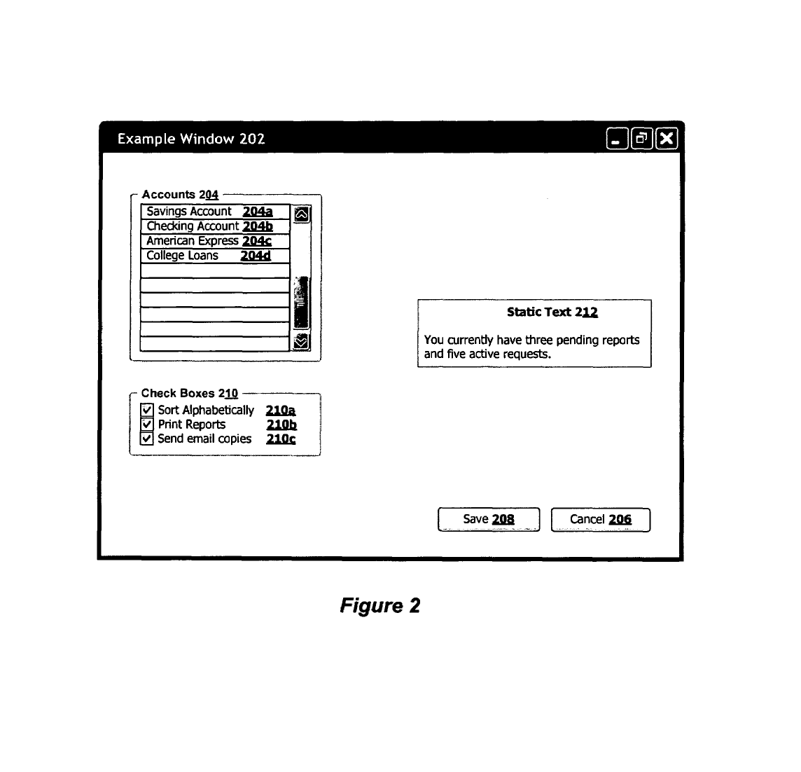

Reference now being made to FIG. 2, a diagram is shown illustrating an example of a graphical representation of a window 202 generated during the execution of the application software 110 of FIG. 1 according to the teachings of a preferred embodiment of the present invention. Application software 110 can be any type of software that generates a graphical representation for providing information to a user in a human readable format (e.g. business, technical, accounting and the like).

In the present example, window 202 is representative of a window type environment such as Windows 2000™ or XP™. This environment, however, is not intended to be a limitation on the types of graphical representations to which the present invention is applicable, but rather, as a convenient and familiar interface from which to provide an explanation of the present invention.

The type and number of components that can be displayed by window 202 are numerous. For ease of explanation, window 202 has been illustrated as having the following components: a group list (Accounts 204), a group of check boxes (Check Boxes 210), static text 212, save button 208, and cancel button 206.

The group list Accounts 204, in this example, displays a group of bank accounts such as Savings Account 204a, Checking Account 204b, American Express 204c, and College Loans 204d.

The check Boxes 210 includes options for sorting the Accounts 204 alphabetically (Sort Alphabetically 210a), printing reports (Print Reports 210b), and sending email copies of the reports (Send email copies 210c).

The static text 212 is used for displaying information such as pending reports and active requests.

In the present example, the native language is English and it can be assumed that there is an end user (e.g. a bilingual translator or individual who is learning or otherwise practicing a foreign language) executing application 110 who desires to display the accounts 104 in Spanish.

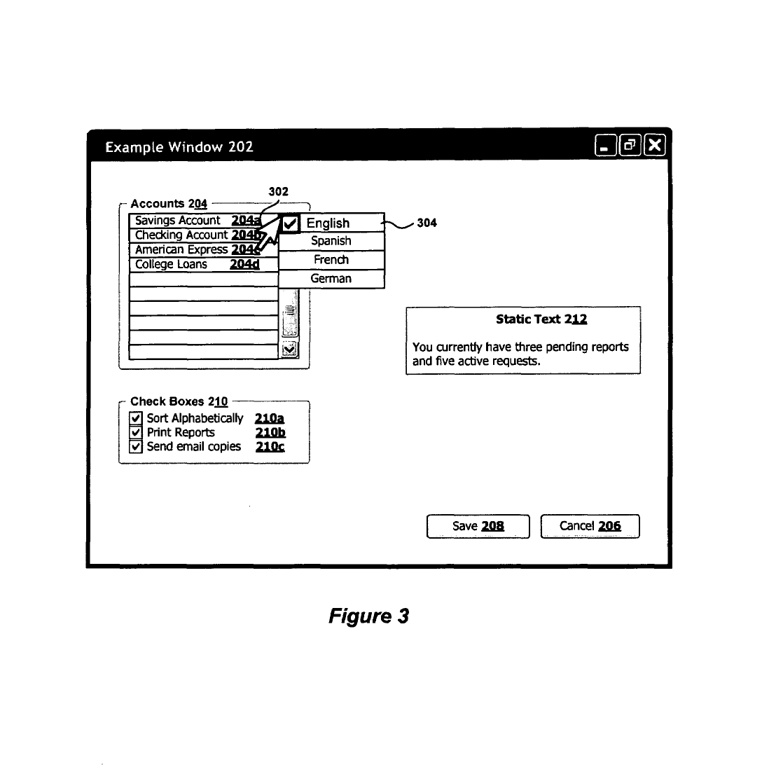

In the preferred embodiment of the present invention, the user employs the mouse (cursor control device 130) and an arrow to select a component as explained in connection with FIG. 3 below. The particular device or method used to select one or more of the components is not intended to be a limitation of the present invention, and in fact, the selection of the component can easily be accomplished using any of the keys on the keyboard (e.g. function, tab, control, etc.)

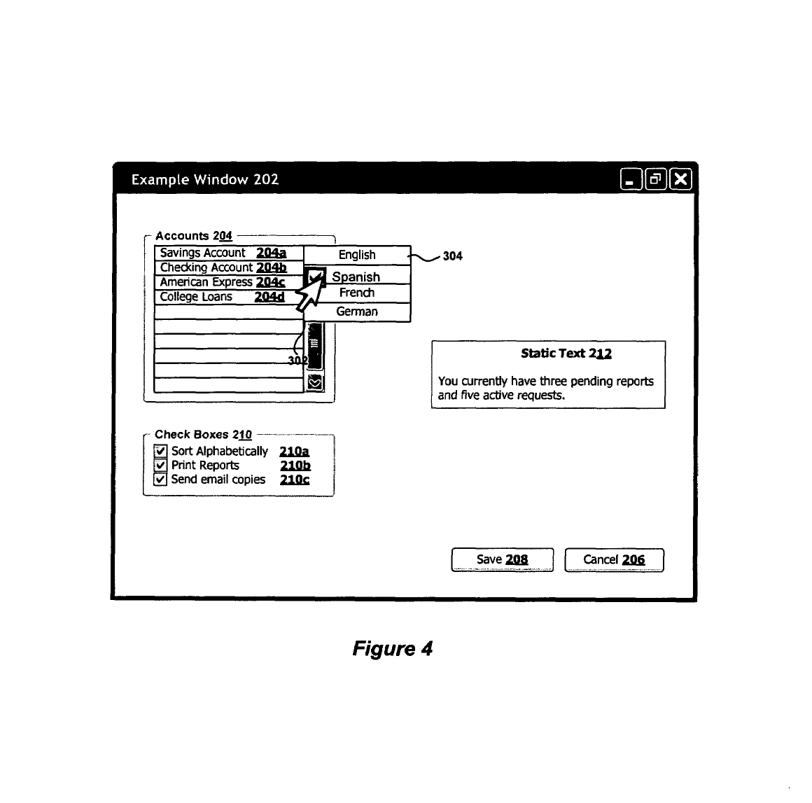

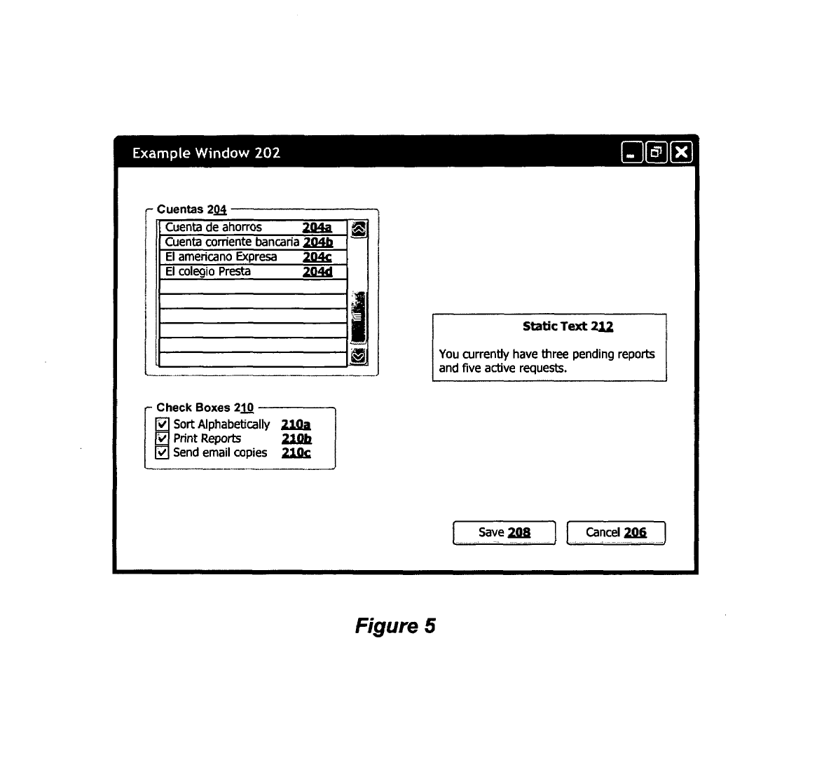

Reference now being made to FIG. 3, a diagram is shown illustrating the window 202 example of FIG. 2 with the user selecting the accounts 204 to be displayed in an alternative language according to the teachings of a preferred embodiment of the present invention. To display accounts 204 in an alternative language, the user manipulates an arrow 302 (or other visual representation) so that it is positioned over the accounts 204 and proceeds to tap the left button on the mouse 130. The taping of the mouse results in the display of a list of available translations 304 for the Accounts 204. As shown, English is illustrated as being the current language of Accounts 204 (via a checkmark). The user employs the arrow 302 to select Spanish as an alternative language for Accounts 204 as illustrated by FIG. 4, and the Accounts 204 is instantly displayed in Spanish and the available translations list 304 disappears as illustrated in FIG. 5.

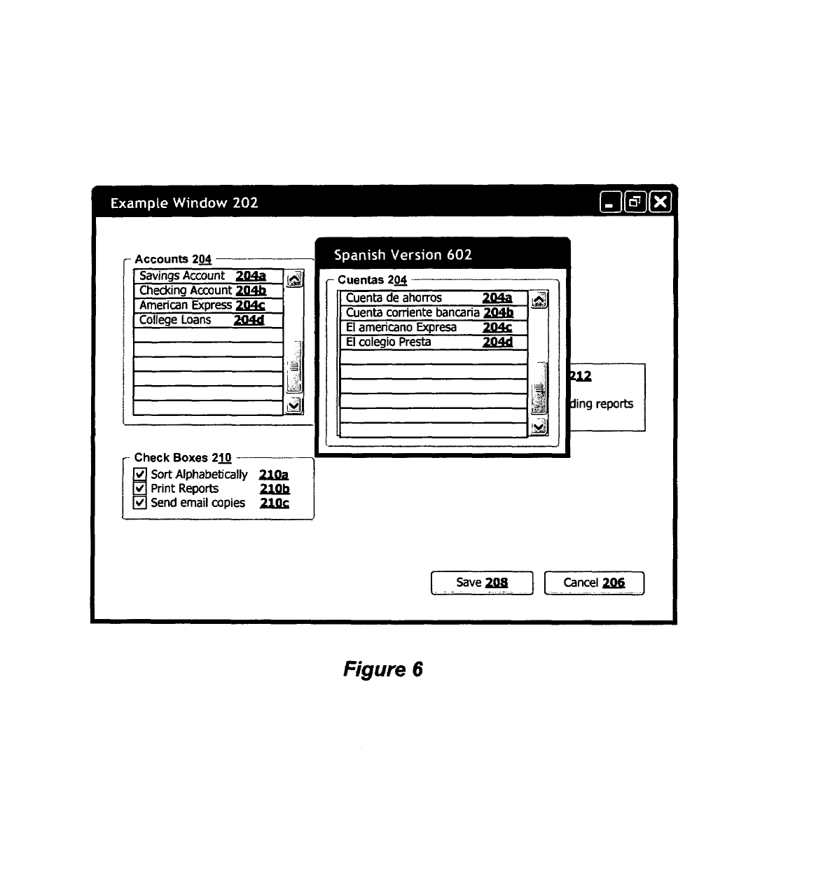

In an alternative preferred embodiment, instead of displaying the Accounts 204 in Spanish, a separate window 602 is used for displaying the Accounts 204 in Spanish as illustrated by FIG. 6. This method has the advantage of allowing the end user to view both languages simultaneously.

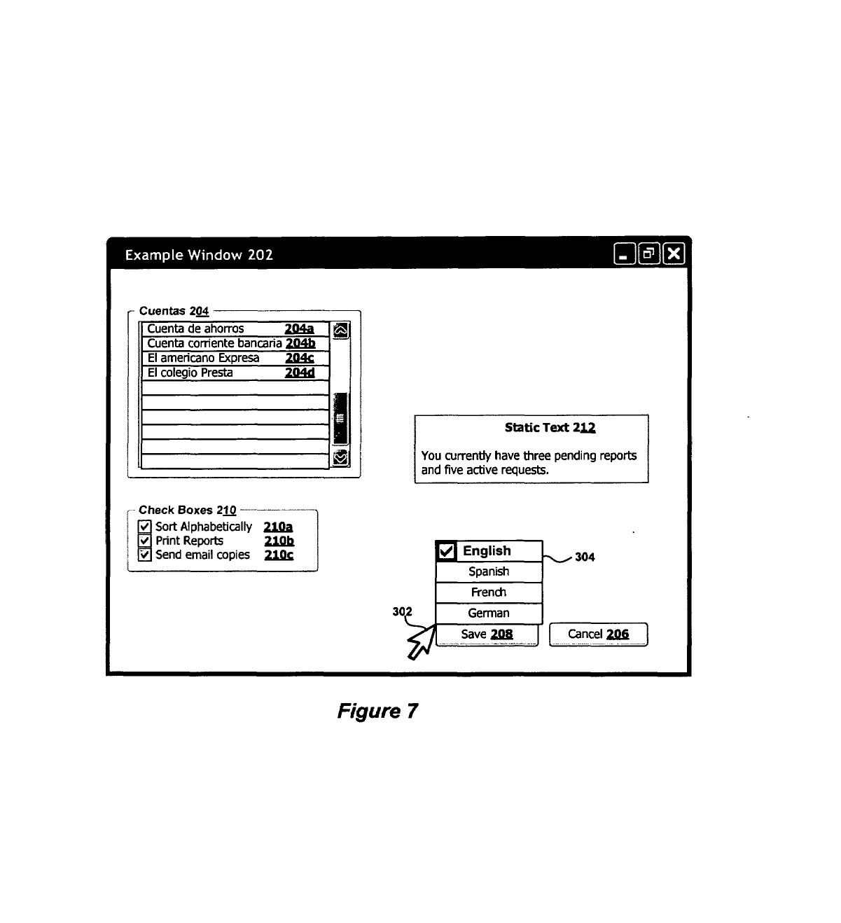

Any text displayed with window 200 (e.g. text displayed by a button) can be selected for an alternative language as illustrated and explained in connection with FIG. 7 below.

Reference now being made to FIG. 7, a diagram is shown illustrating the window 202 example of FIG. 2 with the user selecting the save button 208 to be displayed in an alternative language according to the teachings of a preferred embodiment of the present invention. More specifically, the user now desires to change the save button 208 to the French language. The user employs the arrow 302, and right clicks the mouse 130 to display the supported language list 304. As shown, the save button 208 is currently being displayed in English as indicated by the check mark.

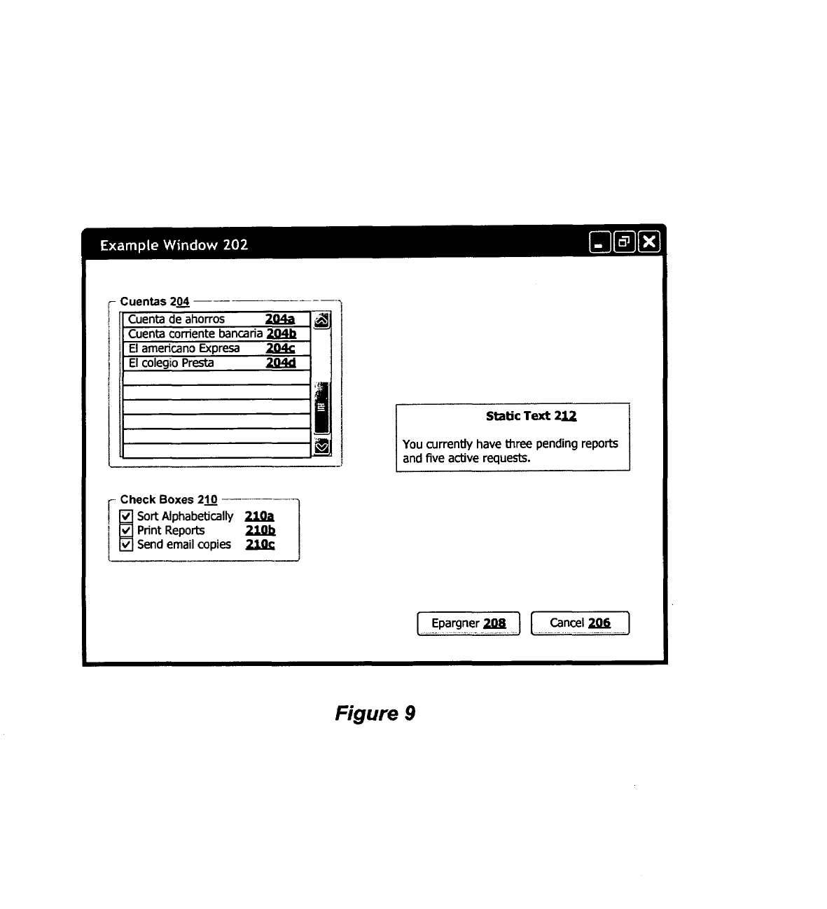

The user employs the arrow 302 to select the displaying of the French language by save button 208 as indicated by the check mark. The arrow 302 and support language list 304 disappear and the Save button 208 is displayed in the French language as illustrated by FIG. 9.

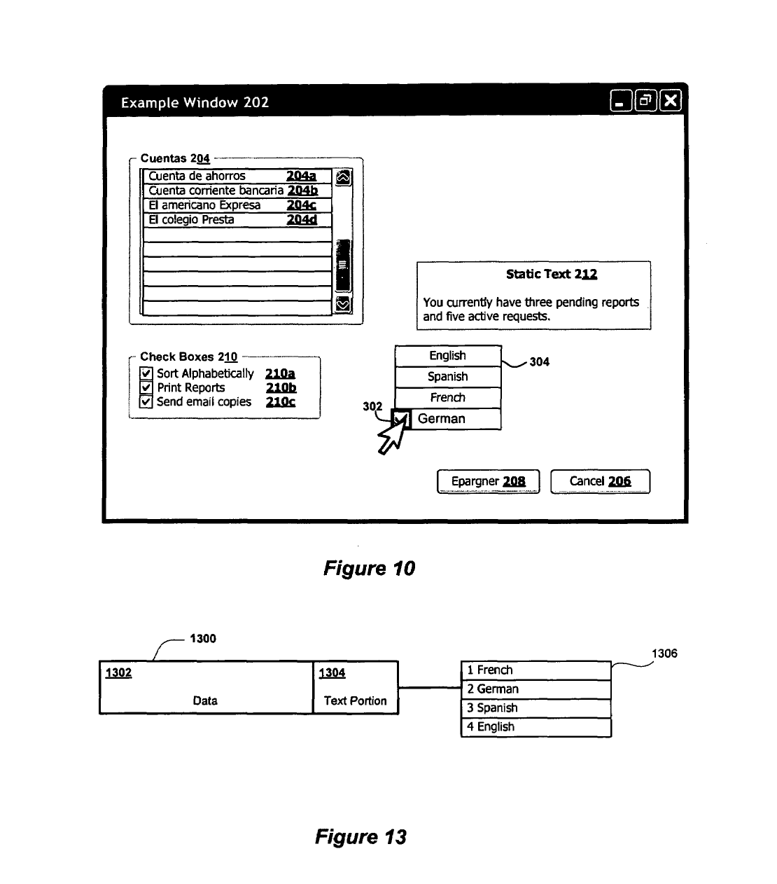

In addition to the ability to select a particular language for each of the individual components of window 202, the user can also specify a single language to be displayed by all of the components as explained in connection with FIGS. 10-12 below.

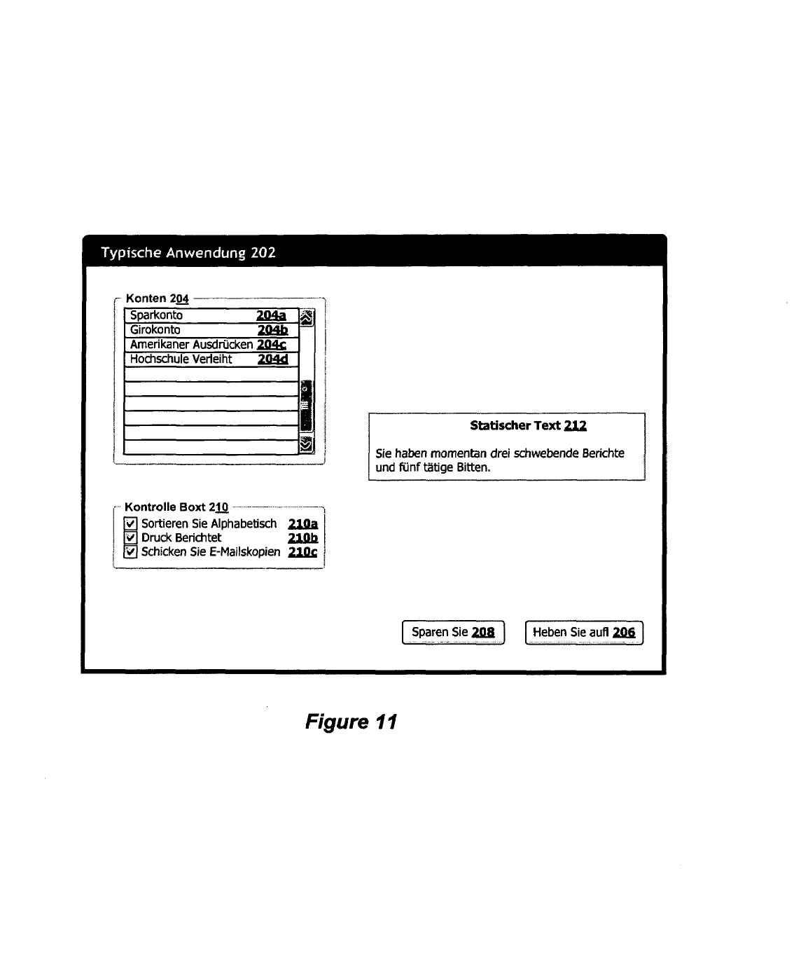

Reference now being made to FIG. 10, a diagram is shown illustrating the window 202 example of FIG. 2 with the user selecting the entire window 202 to be displayed in an alternative language according to the teachings of a preferred embodiment of the present invention. In this example, the user moves the arrow 302 to a position on the screen that will not select another component and right click the mouse 130 resulting in the displaying of the list of alternative languages 304. The user proceeds to select the German language as an alternative language and the window 202 is displayed in the German language as shown by FIG. 11.

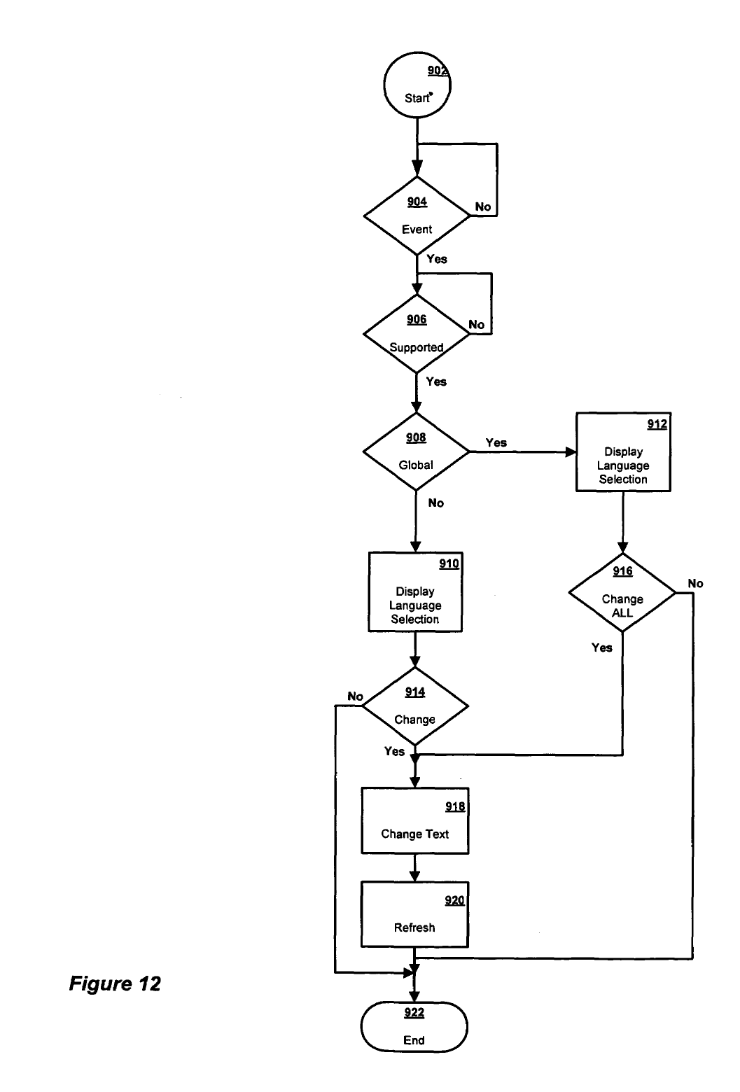

Reference now being made to FIG. 12, a flow chart is shown illustrating the method used by the application 110 of FIG. 1 to render one or more of its components in an alternative language according to the teachings of the present invention.

The method begins with the execution of application 110 (Step 902). The method waits for the occurrence of an event indicating the desire of the user to display an alternative language for one or more of the components of window 202 (right mouse click, hot key, etc.) (Step 904). Upon the occurrence of the event, the method verifies that the display of alternate languages is supported by the one or more components (Step 906). Each of the components that can display text within window 202 has a data structure similar to that explained in connection with FIG. 13 below.

Reference now being made to FIG. 13, a data structure diagram is shown illustrating a preferred data structure 1300 for the displayed components of the window 202 of FIG. 2 according to a preferred embodiment of the present invention. The preferred data structure 1300 includes a data portion 1302 for keeping various types of information such as position, data type and the like. The preferred data structure also includes a text indicator portion 1304 for storing a pointer to the alternative language of the text stored in the text storage file structure 1306.

Text storage file structure 1306 contains the alternative languages supported by the corresponding component of window 202.

In example, if the language selected for a particular component was English, then the text indicator portion would store a pointer to the English text in the text storage file structure 1306.

It should be noted that although the preferred embodiment of the present invention uses the preferred data structure 1300, the present invention is not limited to any particular type of data structure.

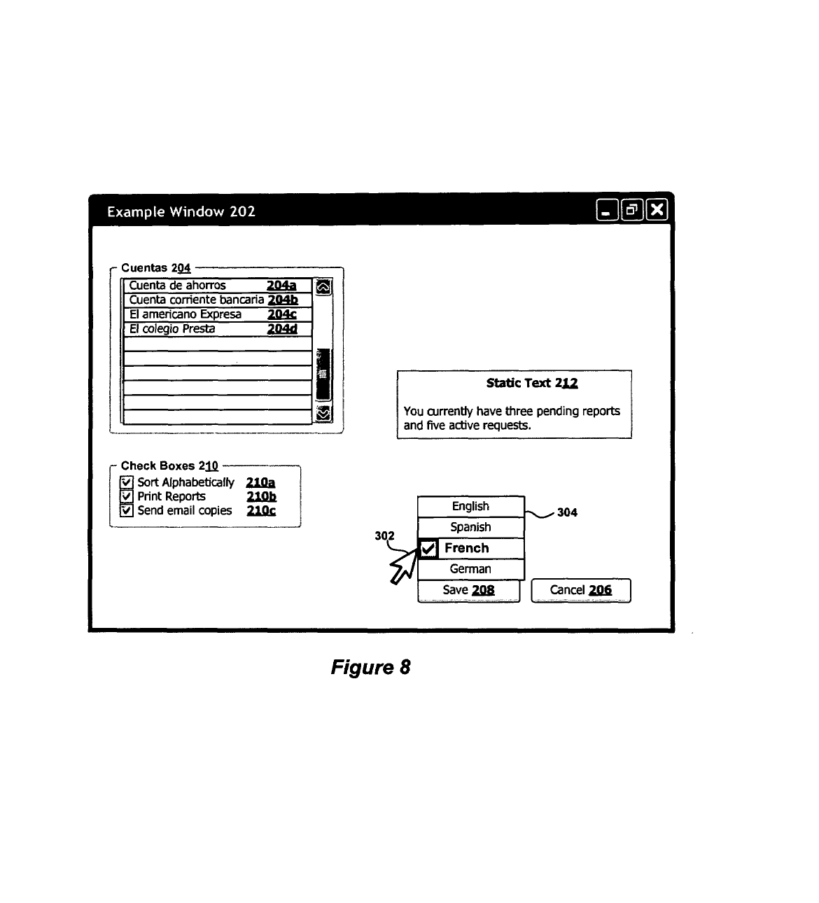

Reference being made to FIG. 12, if the user has indicated a single component (e.g. by selecting the component with the arrow and right clicking the mouse as explained in connection with FIGS. 3-9) (Step 908), then a list of alternative languages is displayed for the selected component (Step 910).

If, however, the user has indicated that all components of the window 202 should be displayed in the same language (e.g. by selecting a portion of the window 202 that has no components and right clicking the mouse as explained in connection with FIGS. 10-11) (Step 908), then a list of alternative languages is displayed for the window 202 (Step 912).

If the user has changed the current language selected for either the individual component or the window (Steps 914-916) then the component or in the case of a global selection all of the components change their text to the selected alternative language (Step 918). Thereafter, the window 202 redraws or refreshes its display so that the alternative language is displayed appropriately (Steps 920-922).

If the user cancels the event or otherwise fails to select an alternative language for the one or more components (Steps 914 or 916) the language displayed by the one or more components is not changed (Step 922).

It is thus believed that the operation and construction of the present invention will be apparent from the foregoing description. While the method, system, and computer program product shown and described has been characterized as being preferred, it will be readily apparent that various changes and/or modifications could be made without departing from the spirit and scope of the present invention as defined in the following claims.

What is claimed is:

1. A method of displaying an alternative language for text rendered by an application executing on a computer system, the method comprising:
displaying the text of one or more components;
selecting an alternative language for the one or more of the components; and
dynamically altering the text of the one or more components to match the selected alternative language.

2. The method of claim 1 wherein the step of selecting includes the step of:
displaying a list of alternative languages for the one or more components.

3. The method of claim 1 further comprising the step of:
selecting one or more of the components.

4. The method of claim 3 wherein the step of selecting includes the steps of:
selecting an alternative language for the selected one or more of the components; and
storing an indication of the selected language for the selected one or more components.

5. The method of claim 1 further comprising the step of:
selecting all of the one or more components.

6. The method of claim 5 wherein the step of selecting includes the step of:
displaying a list of alternative languages for all of the selected components.

7. An apparatus for displaying an alternative language for text rendered by an application executing on a computer system, the apparatus comprising:
means for displaying the text of one or more components;
means for selecting an alternative language for the one or more of the components; and
means for dynamically altering the text of the one or more components to match the selected alternative language.

8. The apparatus of claim 7 wherein the means for selecting includes:
means for displaying a list of alternative languages for the one or more components.

9. The apparatus of claim 7 further comprising:
means for selecting one or more of the components.

10. The apparatus of claim 9 wherein the means for selecting includes:
means for selecting an alternative language for the selected one or more of the components; and
storing an indication of the selected language for the selected one or more components.

11. The apparatus of claim 7 further comprising:
means for selecting all of the one or more components.

12. The apparatus of claim 11 wherein the means for selecting includes:
means for displaying a list of alternative languages for all of the selected components.

13. A computer program product comprising a computer usable medium having computer usable program code for displaying an alternative language for text rendered by an application executing on a computer system, the computer program product including:
computer usable program code for displaying the text of one or more components;
computer usable program code for selecting an alternative language for the one or more of the components; and
computer usable program code for dynamically altering the text of the one or more components to match the selected alternative language.

14. The computer program product of claim 13 wherein the computer usable program code for selecting includes:
computer usable program code for displaying a list of alternative languages for the one or more components.

15. The computer program product of claim 13 further comprising:
computer usable program code for selecting one or more of the components.

16. The computer program product of claim 15 wherein the computer usable program code for selecting includes:
computer usable program code for selecting an alternative language for the selected one or more of the components; and
computer usable program code for storing an indication of the selected language for the selected one or more components.

17. The computer program product of claim 13 further comprising:
computer usable program code for selecting all of the one or more components.

18. The computer program product of claim 17 wherein the computer usable program code for selecting includes:
computer usable program code for displaying a list of alternative languages for all of the selected components.

19. The computer program product of claim 18 wherein a first one of the one or more components is displayed in a first language and a second one of the one or more components is displayed in a second language.

20. The computer program product of claim 19 wherein each one of the one or more components is responsible for rendering their associated text.
